(19) United States
(12) Patent Application Publication
(10) Pub. No.: US 2019/0068522 A1
(43) Pub. Date: Feb. 28, 2019

(54) PACKET SHARING BASED ON IDENTIFIED NEEDS OF DISPARATE USERS

(71) Applicant: Microsoft Technology Licensing, LLC, Redmond, WA (US)

(72) Inventors: Yuval Pinchas Borsutsky, Rishon-Le-Zion (IL); Ariel Baruch, Herzeliya (IL); Ben Grynhaus, Tel Aviv (IL); Keren Damari, Tel Aviv (IL)

(73) Assignee: Microsoft Technology Licensing, LLC, Redmond, WA (US)

(21) Appl. No.: 15/688,616

(22) Filed: Aug. 28, 2017

(51) Int. Cl. H04L 12/927; H04L 1/00; H04L 29/06; H04L 12/721; H04L 12/707

(52) U.S. Cl. CPC H04L 47/808; H04L 1/0006; H04L 69/163; H04L 47/627; H04L 45/44; H04L 45/24; H04L 45/22; H04L 45/34

(57) ABSTRACT

A shared packet transaction amongst disparate users is provided that preserves user data security. A packet unbundling and distribution system is provided that collects packet data associated with packets comprised of divisible packet elements and understands user needs and user preferences of disparate users based on collected user signals. They system identifies a virtual group of disparate users whose user needs and user preferences match at least a portion of the packet's packet elements and satisfy a threshold associated with a packet, and facilities a shared transaction of the packet that benefits each of the disparate users.

### BACKGROUND

Through computing device users' interactions with their computing devices, systems are able to explicitly and implicitly understand the users' needs. Additionally, various online retailers and service providers offer benefits to users who purchase products and services as a quantity-based bundle or as a batched product or service-based bundle. However, users are limited in ways of assembling groups of users with related needs, and user data security is susceptible to theft when sharing a transaction with disparate users.

### SUMMARY

This Summary is provided to introduce a selection of concepts in a simplified form that are further described below in the Detailed Description section. This Summary is not intended to identify key features or essential features of the claimed subject matter, nor is it intended as an aid in determining the scope of the claimed subject matter.

Aspects are directed to an automated system, method, and computer readable storage device for identifying and apportioning a packet amongst disparate users based on each user's needs. For example, a packet unbundling and distribution system is provided that is operative or configured to understand user needs, identify a virtual group of disparate users whose needs can be bundled, match bundled user needs to packet elements, and coordinate a shared transaction of a packet that benefits each of the disparate users. Examples are implemented as a computer process, a computing system, or as an article of manufacture such as a device, computer program product, or computer readable medium. According to an aspect, the computer program product is a computer storage medium readable by a computer system and encoding a computer program of instructions for executing a computer process.

The details of one or more aspects are set forth in the accompanying drawings and description below. Other features and advantages will be apparent from a reading of the following Detailed Description and a review of the associated drawings. It is to be understood that the following Detailed Description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 is a block diagram showing an example operating environment and computing architecture for implementing aspects of the present disclosure;

FIG. 2A shows an example use case where a virtual group is assembled for collaborative sharing of a bundled offer;

FIG. 2B is an illustration of an example user interface display for notifying users of a virtual group of a bundled offer collaboration opportunity that meets the users' needs;

FIG. 3A shows an example use case where a virtual group is assembled for collaborative sharing of a bundled offer;

FIG. 3B is an illustration of an example user interface display for notifying users of a virtual group of a finalized transaction for a bundled offer;

FIG. 4 is a flow chart showing general stages involved in an example method for identifying and apportioning a packet amongst disparate users based on each user's needs;

FIG. 5 is a block diagram illustrating example physical components of a computing device;

FIGS. 6A and 6B are simplified block diagrams of a mobile computing device; and

FIG. 7 is a simplified block diagram of a distributed computing system.

### DETAILED DESCRIPTION

The following Detailed Description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following Detailed Description is not limiting, but instead, the proper scope is defined by the appended claims. Examples may take the form of a hardware implementation, or an entirely software implementation, or an implementation combining software and hardware aspects. The following Detailed Description is, therefore, not to be taken in a limiting sense.

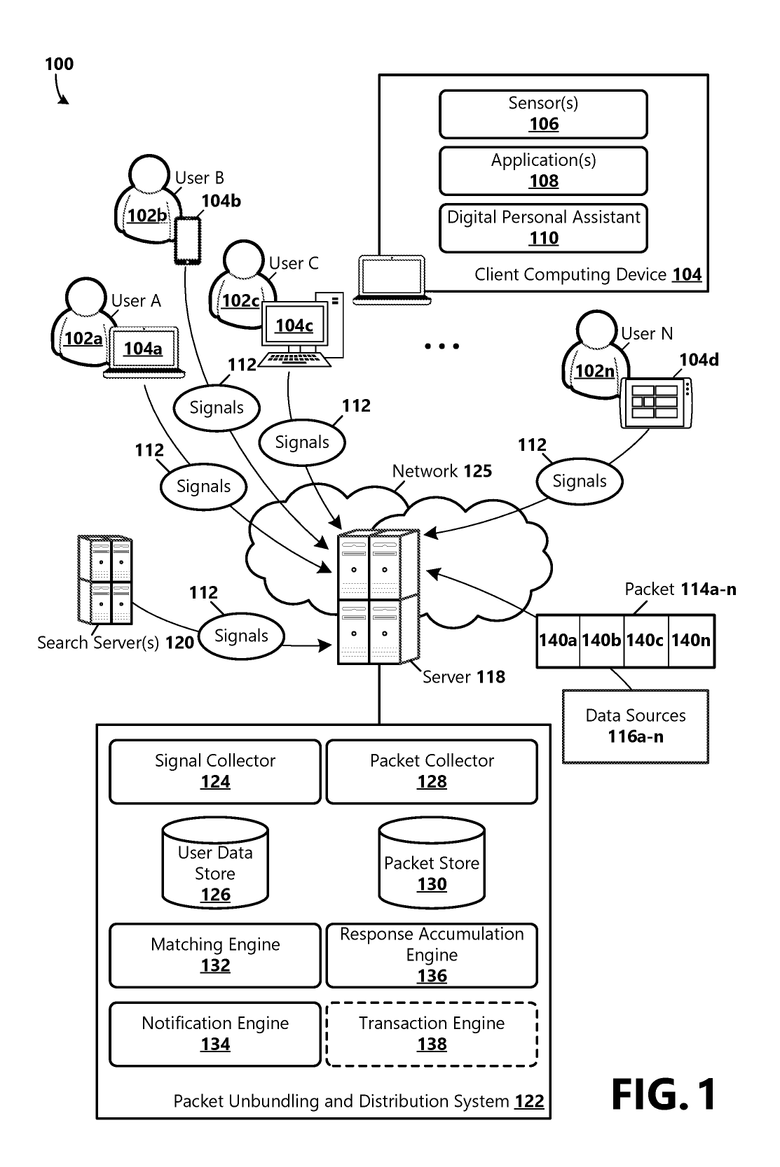

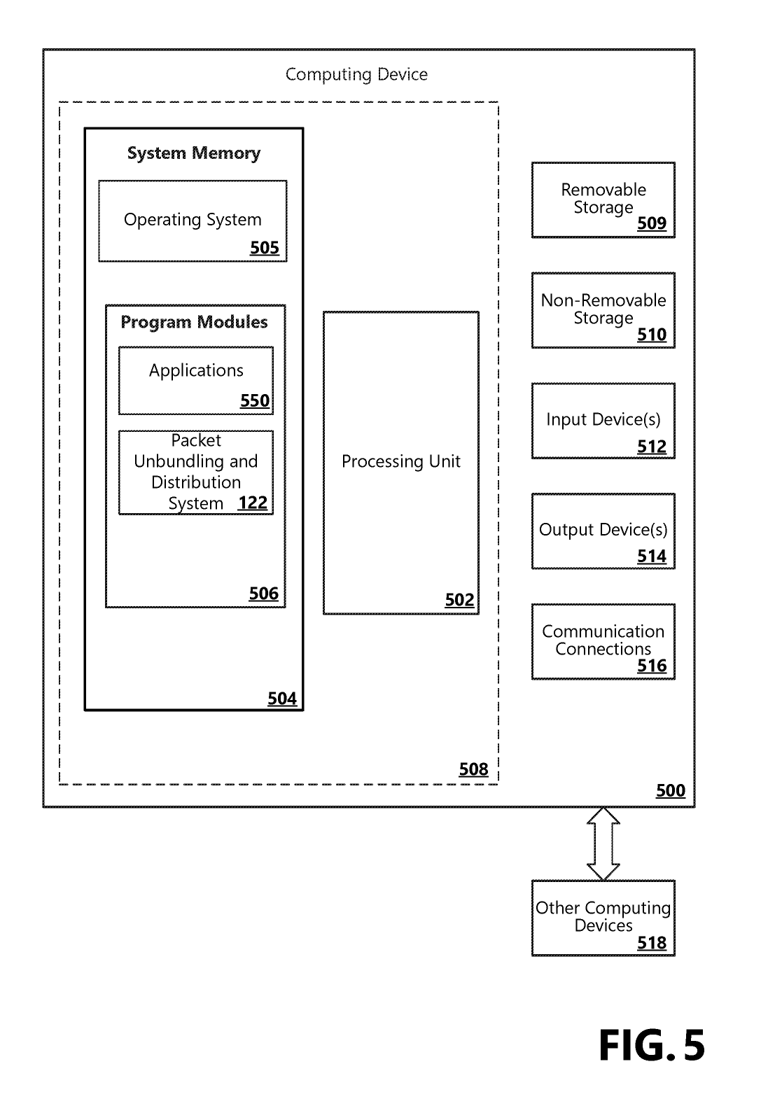

Aspects of the present disclosure are directed to a method, system, and computer readable storage device for identifying and apportioning a packet amongst disparate users based on each user's needs. With reference now to FIG. 1, a block diagram is provided showing an example operating environment 100 and computing architecture in which aspects of the present disclosure can be employed. It should be understood that this and other arrangements described herein are provided as examples. Other arrangements and elements can be used in addition to or instead of those shown in FIG. 1. Various functions described herein as being performed by one or more elements or components can be carried out by hardware, firmware, and/or software. For example, some functions can be carried out by a processor executing instructions stored in memory. As illustrated, the example operating environment 100 includes a plurality of client computing devices 104a-n (generally 104), a number of data sources 116a-n (generally 116), at least one server 118, and network 125. Each of the components illustrated in FIG. 1 can be implemented via any type of computing device, such as the computing devices described in reference to FIGS. 5, 6A, 6B, and 7.

As an example, the one or more client computing devices 104 can be one or more of various types of computing devices, such as tablet computing devices, desktop computers, mobile communication devices, laptop computers, laptop/tablet hybrid computing devices, large screen multi-touch displays, vehicle computing systems, gaming devices, smart televisions, wearable devices, internet of things (IoT) devices, etc. A user 102 can use an application 108 on a client computing device 104 for a variety of tasks, which can include, for example, to write, calculate, draw, take and organize notes, organize and prepare presentations, search for and obtain information, send and receive electronic mail, make music, and the like. Examples of suitable applications 108 include, but are not limited to, word processing applications, spreadsheet applications, slide presentation applications, electronic mail applications, drawing applications, note-taking applications, web browser applications, game applications, and mobile applications. Applications 108 can include thick client applications, which are stored locally on the client computing device 104, or can include thin client applications (i.e., web applications) that reside on a remote server and accessible over a network 125 or a combination of networks. A thin client application can be hosted in a browser-controlled environment or coded in a browser-supported language and can rely on a common web browser to render the application executable on the client computing device 104. In some examples, an application 108 is operative or configured to generate and provide a graphical user interface (GUI) that allows a user 102 to interact with application functionality and electronic content.

In some examples, the client computing device 104 includes or is communicatively attached to a digital personal assistant 110. Digital personal assistant functionality can be provided as or by a stand-alone digital personal assistant application, part of an application 108, or part of an operating system of the client computing device 104. In some examples, the digital personal assistant 110 employs a natural language user interface (UI) that can receive spoken utterances from a user 102 that are processed with voice or speech recognition technology. For example, the natural language UI can include an internal or external microphone, camera, and various other types of sensors 106. The digital personal assistant 110 can support various functions, which can include interacting with the user 102 (e.g., through the natural language UI or GUIs); performing tasks (e.g., making note of appointments in the user's calendar, sending messages and emails, etc.); providing services (e.g., answering questions from the user 102, mapping directions to a destination, other application 108 or service functionalities that are supported by the digital personal assistant 110, etc.); gathering information (e.g., finding information requested by the user 102 about a book or movie, locating the nearest Italian restaurant, etc.); operating the client computing device 104 (e.g., setting preferences, adjusting screen brightness, turning wireless connections on and off); and various other functions. The functions listed above are not intended to be exhaustive and other functions may be provided by the digital personal assistant 110. In examples, the applications 108 or digital personal assistant 110 receive input from the user 102 via various input methods, such as those relying on mice, keyboards, and remote controls, as well as Natural User Interface (NUI) methods, which enable a user 102 to interact with a device in a “natural” manner, such as via speech recognition, touch and stylus recognition, gesture recognition both on screen and adjacent to the screen, air gestures, head and eye tracking, voice and speech, vision, touch, hover, gestures, and machine intelligence.

The components can communicate with each other via network 125, which can include, without limitation, one or more local area networks (LANs) or wide area networks (WANs). In some examples, network 125 comprises the Internet and/or a cellular network, amongst any of a variety of possible public or private networks. As should be appreciated, any number of client computing devices 104, data sources 116, and servers 118, 120 can be employed within the example operating environment 100 within the scope of the present disclosure. Each can comprise a single device or a plurality of devices cooperating in a distributed environment. For example, the server 118 can be provided via multiple devices arranged in a distributed environment that collectively provide various functionalities described herein. In some examples, other components not shown can be included within the distributed operating environment 100.

The example operating environment 100 can be used to implement one or more of the components of a packet unbundling and distribution system 122, including components for collecting user signals 112, identifying user needs 202, identifying packets 114, recognizing divisible packet elements 140, matching disparate users' needs to packet elements 140, and coordinating a shared purchase of a packet 114 amongst disparate users 102 based on the users' needs. The packet unbundling and distribution system 122 illustrated in FIG. 1 represents only one example of a suitable computing system architecture. Other arrangements and elements can be used in addition to or instead of the elements shown. As should be appreciated, elements described herein are functional entities that can be implemented as discrete or distributed components, or in conjunction with other components, and in any suitable combination or location. In some examples, the packet unbundling and distribution system 122 is exposed to users 102 via an API (Application Programming Interface).

As illustrated, the example packet unbundling and distribution system 122 includes a signal collector 124, a user data store 126, a packet collector 128, a packet store 130, a matching engine 132, a notification engine 134, a response accumulation engine 136, and a transaction engine 138. The components of the packet unbundling and distribution system 122 can operate on one or more servers 118, can be distributed across one or more client computing devices 104 and servers 118, or can be implemented in the cloud. In some examples, one or more of the components of the example system are distributed across network 125.

According to an aspect, the signal collector 124 is illustrative of a software module, software package, system, or device operative or configured to receive or collect various signals 112 from the client computing devices 104 and one or more search servers 120. The signal collector 124 is operative or configured to apply machine learning, statistical analysis, behavioral analytics, and data mining techniques to the signals 112 to derive user needs 202 for each user 102. According to an aspect, the signal collector 124 stores the user needs 202, as well as other collected user data (e.g., explicitly-defined or implicitly inferred user preferences), in one or more data stores, such as user data store 126, where the data can be available to other components of the packet unbundling and distribution system 122. For example, a user 102 can explicitly specify specific product or service preferences or features (e.g., brands, hotel star ratings, locations, amenities), or product or service preferences or features can be inferred based on, for example, the user's past purchases or searches.

In some examples, the user data are stored in or associated with a user profile. In some examples, the user data are stored in a relational knowledge graph illustrative of a repository of entities and relationships between entities. In a knowledge graph, entities are represented as nodes, and attributes and relationships between entities are represented as edges connecting the nodes. Thus, a knowledge graph provides a structured schematic of entities and their relationships to other entities. According to examples, edges between nodes can represent an inferred relationship or an explicit relationship. According to an aspect, the user data store 126 is continually updated with data from collected signals 112.

In some examples, the digital personal assistant 110 is present across a plurality of client computing devices 104, and collects and passes various signals 112 to the signal collector 124. In some examples, a user 102 explicitly defines a user need. For example, the user 102 can submit a query (e.g., via the digital personal assistant 110, via a search engine) for a particular product or service (e.g., cameras for sale, “Personal Assistant, I want to buy a new camera”), wherein “camera” is identified as an entity associated with a user need for the user 102. In other examples, the signal collector 124 is operative or configured to infer user needs 202, for example, based on another purchase made by the user 102, based on knowing the user's location and schedule, based on the user's communications, search history, etc. In some examples, the user data received by the signal collector 124 are collected by one or more sensors 106 integrated with or communicatively attached to one or more computing devices, such as one or more client computing devices 104, servers 118, or search servers 120. The one or more sensors 106 can be embodied as hardware, software, or a combination of hardware and software operative or configured to sense, detect, or otherwise obtain user data. By way of example and not limitation, signals 112 can include data that are sensed or determined from the one or more sensors 106, such as location information of a client computing device 104, properties or characteristics of the computing device(s) (such as device state, charging data, date/time, or other information derived from the computing device) and user interaction information (e.g., application usage; online activity; searches; voice data such as automatic speech recognition; activity logs; communications data including calls, texts, instant messages, and emails; website posts; and other user data associated with communication events). In some examples, user interaction information includes information associated with user interactions that occur over more than one computing device. User interaction information can further include user histories, session logs, application data, contacts data, calendar and schedule data, notification data, social-network data, news (including popular or trending items on search engines or social networks), online gaming data, ecommerce activities, user-account(s) data (which can include data from user preferences or settings associated with an application 108 or a digital personal assistant 110), home-sensor data, appliance data, global positioning system (GPS) data, vehicle signal data, traffic data, weather data, wearable device data, other user device data (which may include device settings, profiles, network-related information (e.g., network name or ID, domain information, workgroup information, connection data, wireless network data, or configuration data, data regarding the model number, firmware, or equipment, device pairings, or other network-related information), gyroscope data, accelerometer data, payment or credit card usage data, purchase history data, or other sensor data that may be sensed or otherwise detected by a sensor 106 (or other detector) component(s). For example, other sensor data can include data derived from a sensor component associated with the user 102 (including location, motion, orientation, position, user-access, user interactions, network-access, user device charging, or other data that is capable of being provided by one or more sensors 106), and other sources of data that can be sensed or determined as described herein.

With reference still to FIG. 1, the packet collector 128 is illustrative of a software module, software package, system, or device operative or configured to identify and collect packets 114a-n (generally 114) available to users 102, for example, provided via from a variety of data sources 116 (e.g., product or service providers). According to an aspect and as used herein, the term packet 114 describes goods or services (i.e., packet elements 140a-n (generally 140)) that are offered as a bundle. By way of example and not limitation, packets 114 can include products (e.g., clothing, jewelry, equipment, electronics, tickets, or other products) or services (e.g., taxi or ride shares, travel-related services, moving services, shipping services, rental services, or other services) available for purchase via online retailers or service providers.

In some examples, packet elements 140, when bundled together as a packet 114, are provided at a discounted rate. In some examples, a packet 114 is a bulk purchase of a single product or service, for example, where the packet 114 is comprised of at least a minimum quantity of a particular packet element 140, and a discount is applied based on quantity (e.g., X quantity of product Y will discount each packet element 140 by Z). In other examples, a packet 114 is comprised of a combination of particular packet elements 140, and a discount is applied based on quantity (e.g., X quantity of products A, B, and C will discount each packet element 140 by Z). In other examples, a packet 114 is comprised of particular packet elements 140, and a discount is applied when all or a predetermined portion of specified products in the packet 114 are purchased (e.g., a purchase of product X and product Y triggers a discount Z applied to each packet element 140 or to the whole packet 114).

In some examples, the packet collector 128 includes a data and/or text mining engine to mine, discover, and extract Web-based packet-related content from various Web-based content or data sources 116, such as Web pages. The data sources 116 can be discovered by the packet collector 128 or can be known retailer or service provider sites. In other examples, the packet collector 128 includes a submissions interface that is operative or configured to accept packet-related content from online retailers or service providers.

According to an aspect, the packet collector 128 is further operative or configured to recognize divisible elements of a packet 114. For example, the packet collector 128 analyzes a packet 114, and identifies packet elements 140 that can be distributed amongst a plurality of users 102. For example, a ride-share service can be identified as a packet 114 that can be divided amongst two or more users 102 needing a ride along a similar route. As another example, a packet 114 comprised of five printers can be identified as a packet 114 that can be divided amongst two to five users 102 needing a printer. As another example, a packet 114 comprised of various travel services (e.g., flight, hotel, car rental) can be divided amongst users 102 needed the various travel services. According to an aspect, the packet collector 128 stores packet-related data in the packet store 130, where the data can be available to other components of the packet unbundling and distribution system 122. In some examples, the packet-related data are stored in a relational knowledge graph.

The matching engine 132 is illustrative of a software module, software package, system, or device operative or configured to match user needs 202 associated with a plurality of disparate users 102 to a packet 114. For example, the matching engine 132 maps explicitly-defined or inferred user needs 202 to a packet's packet elements 140. The users 102 whose user needs 202 satisfy at least a minimum threshold of a packet 114 are associated with a virtual group 204. That is, the matching engine 132 establishes a virtual group 204 of disparate users 102 who can benefit from a shared transaction of a packet 114. For example, a benefit can be in the form of a discount or in the availability of a packet element 140 that would otherwise not be feasibly available to a user 102 if not shared amongst a plurality of users 102. According to an example, in establishing a virtual group 204 of disparate users 102, the matching engine 132 is operative or configured to identify users 102 who share a common or similar user need 202, and whose user needs 202 can be bundled together as a shared transaction. According to an example, as used herein, the term “transaction” is used to describe a purchase of a divisible or shareable packet 114. According to an aspect, the matching engine 132 detects common or related user needs 202 that can be combined and mapped to a packet 114.

According to an aspect, the matching engine 132 is further operative or configured to use explicitly-defined or implicitly inferred user preferences for mapping user needs 202 to packet elements 140. In some examples, the matching engine 132 assembles virtual groups 204 of disparate users 102 based in part on common or similar user preferences. For example, users 102 who share a common preference for a particular product brand or who only purchase products or services that meet a minimum rating can be assembled into a virtual group 204.

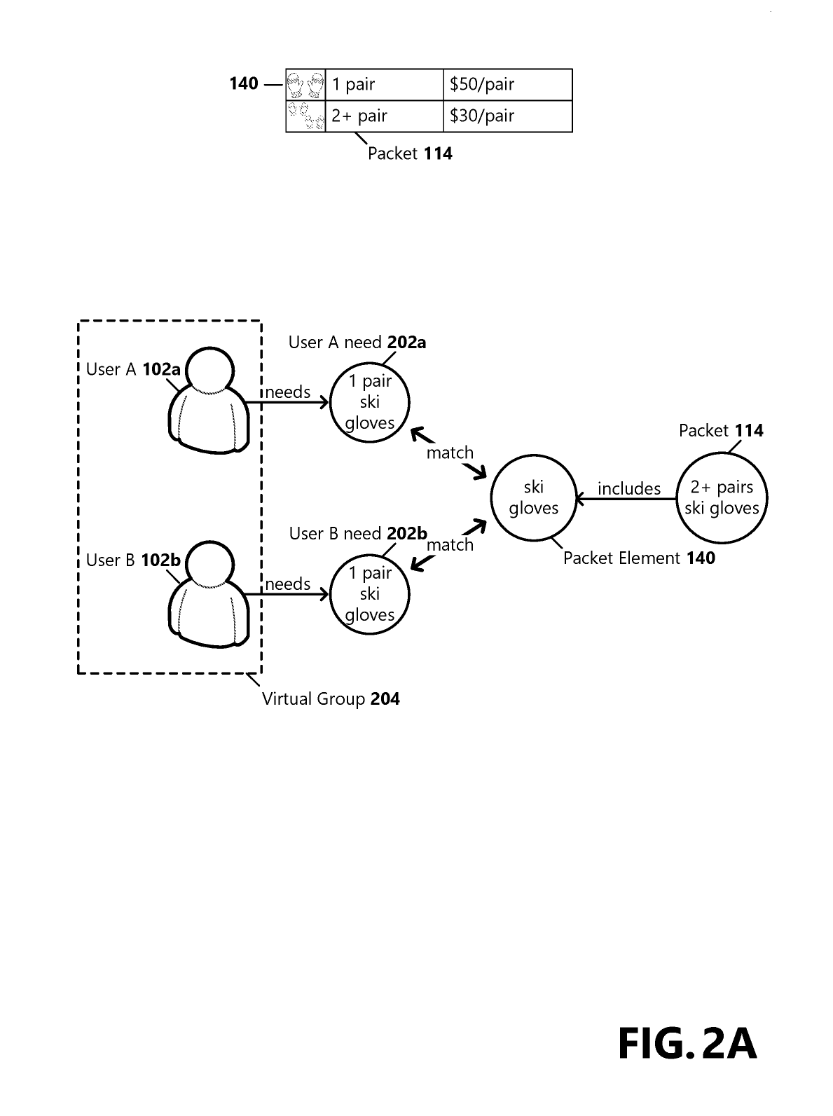

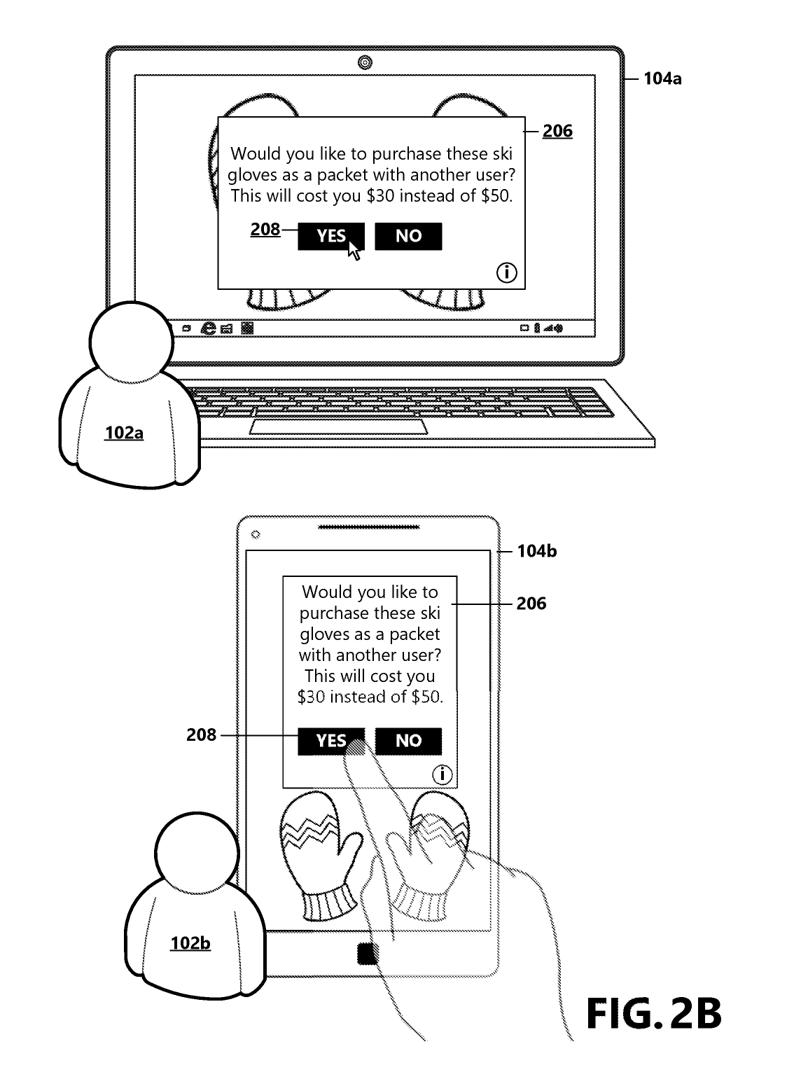

In some examples, the matching engine 132 ranks packet elements 140 based on a level of relatedness between a packet element 140 and an identified user need and user preferences. For example, a particular packet element 140 (e.g., a refrigerator) of a packet 114 (e.g., an appliance set including a refrigerator, stove, and a dishwasher) can be determined to match a user need for a particular user 102; however, the user 102 may have certain explicitly-defined or inferred user preferences associated with the packet element 140 that are not closely related to the particular packet element 140. For example, the particular user 102 may explicitly define a preference for a stainless steel refrigerator with a touchscreen, or an inference can be made that the user 102 has a preference for a stainless steel refrigerator with a touchscreen, for example, based on the user's previous searches, previous purchases, communications, etc. Accordingly, the matching engine 132 can determine that a mapping between a black refrigerator that does not include a touchscreen (packet element 140) that is batched in a packet 114 with other appliances is not closely related, and thus not a strong match for the user 102. In some examples, a match between a user need and a packet element 140 is determined according to a calculated relatedness score. Mapping user needs 202 to packet elements 140 for assembling a virtual group 204 of disparate users 102 for sharing a packet 114 is described in further detail below with reference to examples illustrated in FIGS. 2A-B and 3A-B.

With reference still to FIG. 1, the notification engine 134 is illustrative of a software module, software package, system, or device operative or configured to notify each user 102 of an assembled virtual group 204 about a proposal of a shared transaction of a packet 114 that the virtual group 204 is associated with and of the one or more packet elements 140 with which the particular user 102 is matched. In some examples, the notification 206 is an offer that users 102 of a virtual group 204 are enabled to respond to for opting into the shared packet transaction. For example, a notification 206 sent to identified users 102 of a virtual group 204 matched to packet elements 140 of a packet 114 can prompt each user 102 to respond to an offer to participate in a shared packet transaction (e.g., whether the user 102 would like to purchase item X as a bundle with another user 102). In some examples, the notification 206 can further include information associated with the benefit to the user 102 (e.g., a discount). Further, the notification 206 can include a selectable option 208 to participate in the shared packet transaction. The notification 206 can be provided via the digital personal assistant 110, via an application 108, or exposed via an API.

According to an aspect, the packet unbundling and distribution system 122 comprises a response accumulation engine 136 illustrative of a software module, software package, system, or device operative or configured to accumulate responses to the notifications from users 102. For example, when a user 102 selects to participate in a shared packet transaction, the response accumulation engine 136 collects the response and makes a determination as to whether a threshold for the packet 114 has been satisfied (e.g., at least a minimum number of users 102 have selected to participate or whether each packet element 140 of a packet 114 has been matched to and accepted by a user 102). In some examples, the threshold is associated with the benefit or profitability to the users 102 of a virtual group 204.

In some examples, responsive to satisfying the threshold, the notification engine 134 is further operative or configured to notify the users 102 that the shared packet transaction has been successfully approved (i.e., the threshold has been satisfied) such that each of the user 102 can finalize their pieces of the shared packet transaction. According to an example, packet transaction capabilities are exposed to the user 102 via the notification 206. In other examples, responsive to satisfying the threshold, an optional transaction engine 138, illustrative of a software module, software package, system, or device, is operative or configured to facilitate the shared packet transaction on behalf of one or more of the users 102 of the virtual group 204. For example, using known or stored user payment or credit card data, the transaction engine 138 can perform the purchase of the packet 114 and collect or facilitate payment for each user's portion of the packet 114. As another example, the transaction engine 138 can secure a reservation for a product or service on behalf of a user 102. In some examples, an interface is provided for enabling users 102 to enter payment, shipping, and other required transaction data.

Advantageously, the disclosed aspects enable the benefit of technical effects that include, but are not limited to, improved individual user data security and reductions in bandwidth while providing an improved user experience. According to an aspect, the packet unbundling and distribution system 122 improves user data security in shared packet transaction scenarios by enabling disparate users 102 who are not located in a same location to collaborate on a transaction securely, for example, without requiring the users 102 to share sensitive user data (e.g., payment data, bank data, credit card data, personal information) and without requiring the users 102 to be in direct communication with each other. Further, by automatically retrieving packet-related data from various data sources 116 that are relevant to users' needs and preferences, additional processing and bandwidth usage associated with searches for products or services that satisfy the users' needs and preferences are reduced.

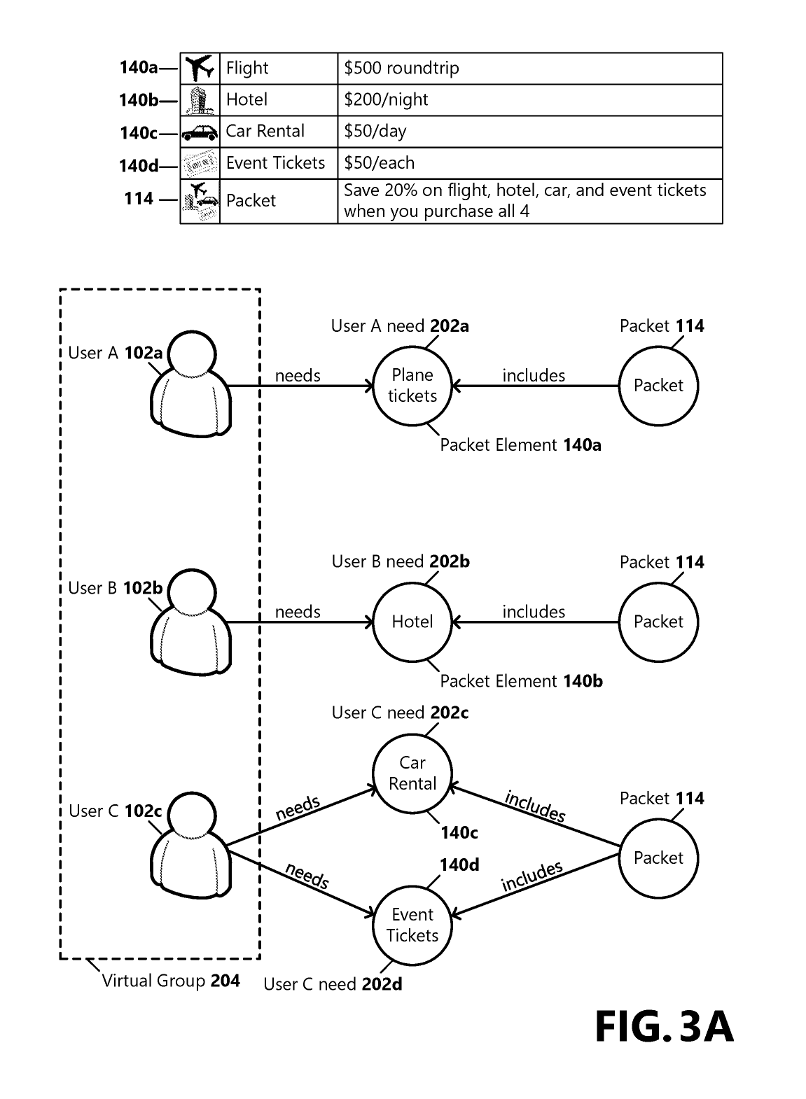

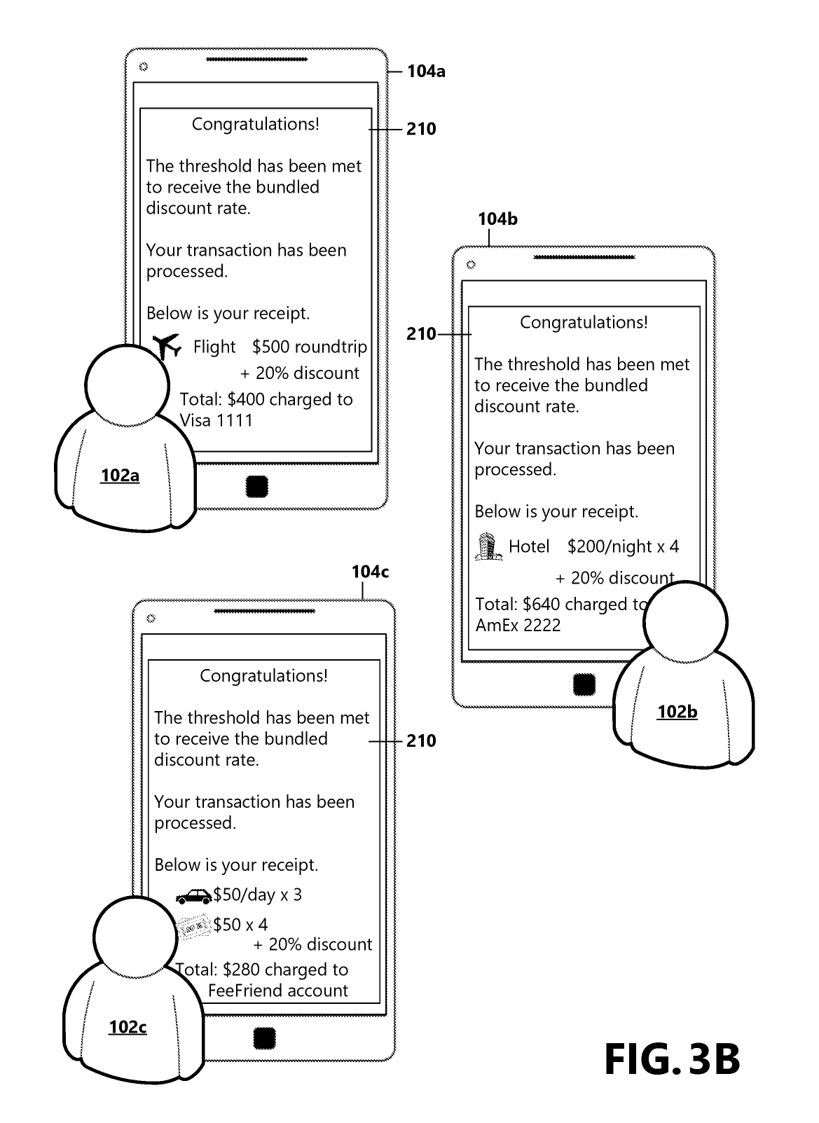

Various examples are described below with reference to FIGS. 2A-B and FIGS. 3A-B. With reference now to FIG. 2A, an example packet 114 is shown, wherein the example packet is comprised of a plurality of packet elements 140. In the illustrated example, the packet element 140 comprises a pair of ski gloves that when quantity-batched (e.g., purchased in a quantity of two or more pairs), provide a benefit (e.g., discount) to the client. Further as illustrated, two users, User A 102a and User B 102b are shown grouped together in a virtual group 204. For example, a pair of ski gloves is identified by the signal collector 124 as a user need 202a for User A 102a, and the identified (e.g., explicitly or implicitly) user need is stored in the user data store 126 in association with User A. Likewise, a pair of ski gloves is identified (e.g., explicitly or implicitly) by the signal collector 124 as a user need 202b for User B 102b, and stored in the user data store 126 in association with User B. Further, a quantity-bundled packet 114 of ski gloves (packet element 140) is identified and collected by the packet collector 128. The packet 114 data is stored in the packet store 130, where it is available to the matching engine 132 for mapping the packet's packet elements 140 to user needs 202 stored in the user data store 126. As illustrated, matches are determined between User A's identified user need 202a of a pair of ski gloves and a packet element 140 (a pair of ski gloves) and between User B's identified user need 202b of a pair of ski gloves and a packet element 140 (a pair of ski gloves). According to an aspect, explicitly-defined or inferred user preference data can be used in determining the matches. In the example, the threshold of the packet 114 is a quantity of two pairs of ski gloves. Accordingly, upon identifying the matches, the threshold is determined to be satisfied, and the users are notified.

With reference now to FIG. 2B, an example notification 206 is shown displayed on User A's client computing device 104a and on User B's client computing device 104b. As should be appreciated, the example notification 206 is for illustrative purposes only. Other types of notifications can be provided in a variety of formats and modes, and are within the scope of the present disclosure. In the illustrated example, a selectable option 208 is provided for enabling the users 102a, b to opt into the shared packet transaction. Upon selections by both users 102a, b to opt into the shared packet transaction, the transaction is finalized, and the users 102 are provided the benefit of the bundled packet 114.

With reference now to FIG. 3A, another example packet 114 is shown, wherein the example packet 114 is travel-related and comprised of a plurality of packet elements 140. In the illustrated example, the packet 114 is comprised of a combination of four packet elements 140: plane ticket packet elements 140a, hotel accommodation packet elements 140b, a car rental packet element 140c, and event ticket packet elements 140d. For example, when purchased as a bundle, a benefit of a 20% discount is provided. As illustrated, User A 102a has a user need 202a of plane ticket packet elements 140a to Paris, France, User 102b has a user need 202b of hotel accommodation packet elements 140b in Paris, and User C 102c has a user need 202c of a car rental packet elements 140c and event ticket packet elements 140d in Paris are obtained, identified, and stored in the user data store 126 in association with the particular users 102a-c. Further, the travel-related packet 114 is identified and stored in the packet store 130. The matching engine 132 maps the users' user needs 202a-d to the packet elements 140a-d, and detects the users' common user needs 202 that can be combined to satisfy the threshold (e.g., batched purchase of flight, hotel, car, and event tickets) associated with the travel-related packet 114. Further, the matching engine 132 assembles a virtual group 204 comprised of User A 102a, User B 102b, and User C 102b whose combined user needs 202a-d satisfy the packet threshold.

With reference now to FIG. 3B, an example notification 210 is shown displayed on User A's client computing device 104a, on User B's client computing device 104b, and on User C's client computing device 104c. In the illustrated example, the example notification 210 is a notification provided to the users 102a-c responsive to the finalized shared packet transaction. For example, prior to receiving the example notification 210, the users 102a-c can be notified of the batched offer in another notification 210 and opt into the transaction. As can be appreciated, the users' private user data (e.g., payment data, bank data, credit card data, personal information) is not shared with the other users 102, thus providing a secure transaction of a shared packet 114.

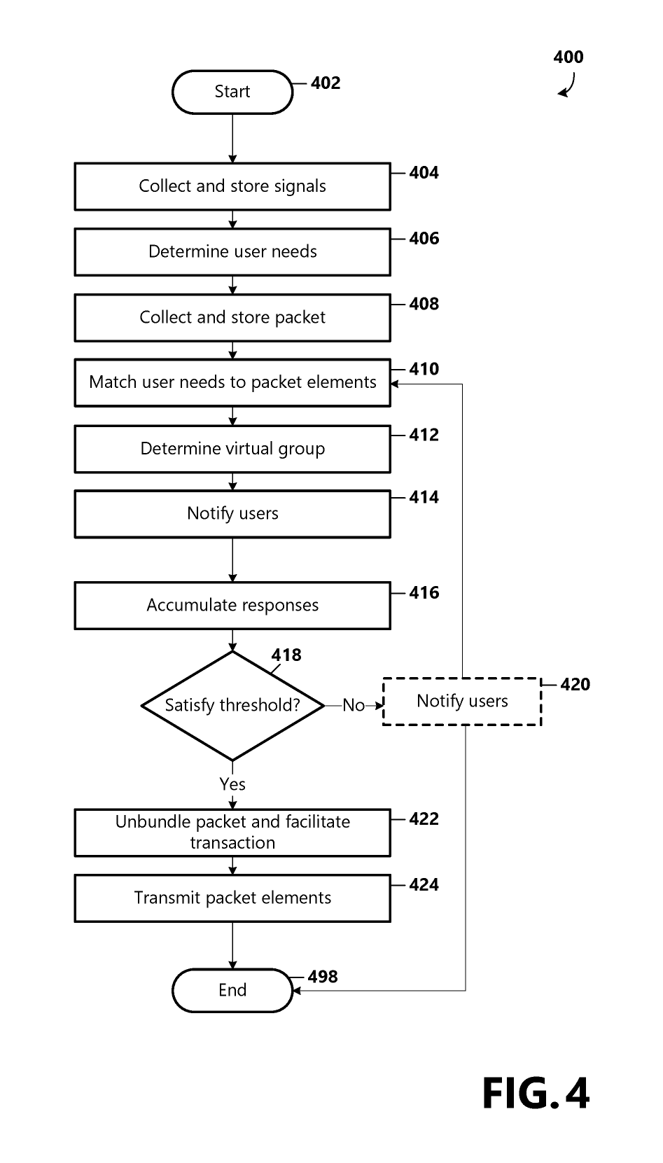

Having described an operating environment 100, example packet unbundling and distribution system 122, and examples with respect to FIGS. 1-3B, FIG. 4 is a flow chart showing general stages involved in an example method 400 for identifying and apportioning a packet 114 amongst disparate users 102 based on each user's identified user needs 202. With reference now to FIG. 4, the method 400 begins at start OPERATION 402, and proceeds to OPERATION 404, where user signals 112 associated with various disparate users 102 are collected based on the users' interactions with their client computing devices 104. For example the user signals 112 can include data that are sensed or determined from the one or more sensors 106 and user interactions (e.g., searches, queries, communications, purchase histories, browsing histories).

At OPERATION 406, machine learning, statistical analysis, behavioral analytics, and data mining techniques are applied to the signals 112 to derive user needs 202 for each user 102. According to an aspect, the identified user needs 202, as well as other collected user data (e.g., explicitly-defined or implicitly inferred user preferences, payment information, billing and shipping address information), are stored in the user data store 126, where the data can be available to other components of the packet unbundling and distribution system 122.

The method 400 proceeds to OPERATION 408, where packets 114 provided via one or more data sources 116 are identified, collected, analyzed, and stored in the packet store 130. For example, identified packets 114 are analyzed for identifying divisible elements of a packet 114 that can be apportioned to various disparate users 102 in a shared transaction.

The method 400 continues to OPERATION 410, where the identified user needs 202 are mapped to packet elements 140, and matches are made between various user needs 202 and packet elements 140 based on a relatedness factor. In some examples, user preference data are used in determining the relatedness score of a match between a user need 202 and a packet element 140. Packet elements 140 of a packet 114 are mapped to user needs 202 at least until a minimum threshold associated with the packet 114 are satisfied.

At OPERATION 412, a determination is made that a threshold associated with a packet 114 is satisfied (e.g., at least a minimum quantity or combination of packet elements 140 are matched with users' user needs 202), and the users 102 whose user needs 202 satisfy the packet threshold are identified as a virtual group 204.

The method 400 proceeds to OPERATION 414, where the users 102 of the virtual group 204 are notified of a match between the user's identified user need(s) 202 and at least one packet element 140 of a packet 114 that is able to be apportioned amongst a group of disparate users 102 who can benefit from a shared transaction of the packet 114.

The method 400 continues to OPERATION 416, where responses to the notification 206 are collected, and at DECISION OPERATION 418, a determination is made as to whether the responses of users 102 who have decided to opt in satisfy a threshold for the packet 114. When a determination is made that the responses do not satisfy the packet threshold, the method 400 optionally proceeds to OPERATION 420, where the users 102 are notified, or returns to OPERATION 410, where the packet elements 140 are mapped to other users' user needs 202 for identifying a match to another user 102.

When a determination is made that the responses satisfy the packet threshold, the method 400 proceeds to OPERATION 422, where the packet 114 is unbundled. For example, the packet elements 140 are apportioned amongst the users 102 of the virtual group 204 based on the users' identified user needs 202, and the shared packet transaction is finalized. In some examples, the packet unbundling and distribution system 122 facilitates the transactions of the matched packet elements 140. For example, the packet unbundling and distribution system 122 can transmit payment to a product or service provider on behalf of the users 102, or can secure a reservation for a product or service on behalf of the users 102.

The method 400 continues to OPERATION 424, where the packet elements 140 are transmitted. In some examples, the transmission of the packet elements 140 comprises a transmission of notifications, receipts, or of transaction details. In other examples, the transmission of the packet elements 140 comprises a transmission of physical entities or provision of services. The method 400 ends at END OPERATION 498.

While implementations have been described in the general context of program modules that execute in conjunction with an application program that runs on an operating system on a computer, those skilled in the art will recognize that aspects can also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 5-7 and the associated descriptions provide a discussion of a variety of operating environments in which examples are practiced. However, the devices and systems illustrated and discussed with respect to FIGS. 5-7 are for purposes of example and illustration and are not limiting of a vast number of computing device configurations that are used for practicing aspects, described herein.

FIG. 5 is a block diagram illustrating physical components (i.e., hardware) of a computing device 500 with which examples of the present disclosure may be practiced. In a basic configuration, the computing device 500 includes at least one processing unit 502 and a system memory 504. According to an aspect, depending on the configuration and type of computing device, the system memory 504 comprises, but is not limited to, volatile storage (e.g., random access memory), non-volatile storage (e.g., read-only memory), flash memory, or any combination of such memories. According to an aspect, the system memory 504 includes an operating system 505 and one or more program modules 506 suitable for running software applications 550. According to an aspect, the system memory 504 includes the one or more components of the packet unbundling and distribution system 122. The operating system 505, for example, is suitable for controlling the operation of the computing device 500. Furthermore, aspects are practiced in conjunction with a graphics library, other operating systems, or any other application program, and is not limited to any particular application or system. This basic configuration is illustrated in FIG. 5 by those components within a dashed line 508. According to an aspect, the computing device 500 has additional features or functionality. For example, according to an aspect, the computing device 500 includes additional data storage devices (removable and/or non-removable) such as, for example, magnetic disks, optical disks, or tape. Such additional storage is illustrated in FIG. 5 by a removable storage device 509 and a non-removable storage device 510.

As stated above, according to an aspect, a number of program modules and data files are stored in the system memory 504. While executing on the processing unit 502, the program modules 506 (e.g., one or more components of the packet unbundling and distribution system 122) perform processes including, but not limited to, one or more of the stages of the method 400 illustrated in FIG. 4. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, aspects are practiced in an electrical circuit comprising discrete electronic elements, packaged or integrated electronic chips containing logic gates, a circuit using a microprocessor, or on a single chip containing electronic elements or microprocessors. For example, aspects are practiced via a system-on-a-chip (SOC) where each or many of the components illustrated in FIG. 5 are integrated onto a single integrated circuit.

According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 500 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 500 has one or more input device(s) 512 such as a keyboard, a mouse, a pen, a sound input device, a touch input device, etc. The output device(s) 514 such as a display, speakers, a printer, etc. are also included according to an aspect. The aforementioned devices are examples and others may be used. According to an aspect, the computing device 500 includes one or more communication connections 516 allowing communications with other computing devices 518. Examples of suitable communication connections 516 include, but are not limited to, radio frequency (RF) transmitter, receiver, and/or transceiver circuitry; universal serial bus (USB), parallel, and/or serial ports.

The term computer readable media as used herein include computer storage media. Computer storage media include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (i.e., memory storage.) According to an aspect, computer storage media include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. According to an aspect, any such computer storage media is part of the computing device 500. Computer storage media do not include a carrier wave or other propagated data signal.

According to an aspect, communication media are embodied by computer readable instructions, data structures, program modules, or other data in a modulated data signal, such as a carrier wave or other transport mechanism, and includes any information delivery medium. According to an aspect, the term “modulated data signal” describes a signal that has one or more characteristics set or changed in such a manner as to encode information in the signal. By way of example, and not limitation, communication media include wired media such as a wired network or direct-wired connection, and wireless media such as acoustic, radio frequency (RF), infrared, and other wireless media.

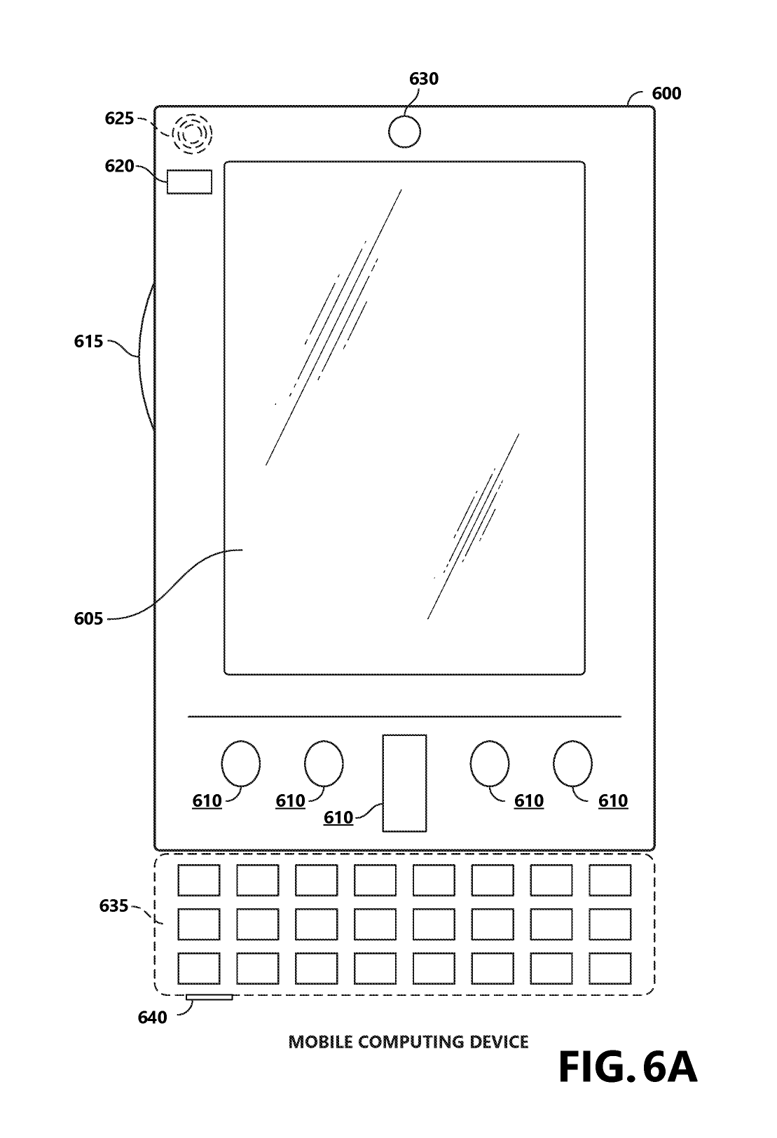

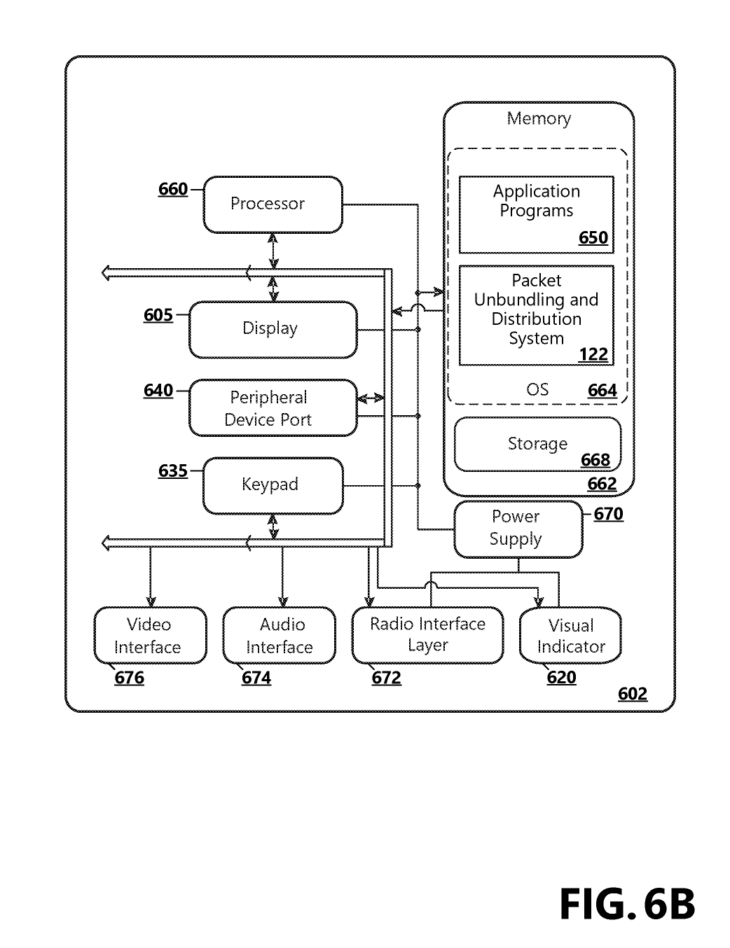

FIGS. 6A and 6B illustrate a mobile computing device 600, for example, a mobile telephone, a smart phone, a tablet personal computer, a laptop computer, and the like, with which aspects may be practiced. With reference to FIG. 6A, an example of a mobile computing device 600 for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600.

According to an aspect, the display 605 of the mobile computing device 600 functions as an input device (e.g., a touch screen display). If included, an optional side input element 615 allows further user input. According to an aspect, the side input element 615 is a rotary switch, a button, or any other type of manual input element. In alternative examples, mobile computing device 600 incorporates more or less input elements. For example, the display 605 may not be a touch screen in some examples. In alternative examples, the mobile computing device 600 is a portable phone system, such as a cellular phone. According to an aspect, the mobile computing device 600 includes an optional keypad 635. According to an aspect, the optional keypad 635 is a physical keypad. According to another aspect, the optional keypad 635 is a “soft” keypad generated on the touch screen display. In various aspects, the output elements include the display 605 for showing a graphical user interface (GUI), a visual indicator 620 (e.g., a light emitting diode), and/or an audio transducer 625 (e.g., a speaker). In some examples, the mobile computing device 600 incorporates a vibration transducer for providing the user with tactile feedback. In yet another example, the mobile computing device 600 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 600 incorporates peripheral device port 640, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one example of a mobile computing device. That is, the mobile computing device 600 incorporates a system (i.e., an architecture) 602 to implement some examples. In one example, the system 602 is implemented as a “smart phone” capable of running one or more applications (e.g., browser, e-mail, calendaring, contact managers, messaging clients, games, and media clients/players). In some examples, the system 602 is integrated as a computing device, such as an integrated personal digital assistant (PDA) and wireless phone.

According to an aspect, one or more application programs 650 are loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. According to an aspect, one or more components of the packet unbundling and distribution system 122 are loaded into memory 662. The system 602 also includes a non-volatile storage area 668 within the memory 662. The non-volatile storage area 668 is used to store persistent information that should not be lost if the system 602 is powered down. The application programs 650 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600.

According to an aspect, the system 602 has a power supply 670, which is implemented as one or more batteries. According to an aspect, the power supply 670 further includes an external power source, such as an AC adapter or a powered docking cradle that supplements or recharges the batteries.

According to an aspect, the system 602 includes a radio 672 that performs the function of transmitting and receiving radio frequency communications. The radio 672 facilitates wireless connectivity between the system 602 and the “outside world,” via a communications carrier or service provider. Transmissions to and from the radio 672 are conducted under control of the operating system 664. In other words, communications received by the radio 672 may be disseminated to the application programs 650 via the operating system 664, and vice versa.

According to an aspect, the visual indicator 620 is used to provide visual notifications and/or an audio interface 674 is used for producing audible notifications via the audio transducer 625. In the illustrated example, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user 102. For example, in addition to being coupled to the audio transducer 625, the audio interface 674 may also be coupled to a microphone to receive audible input, such as to facilitate a telephone conversation. According to an aspect, the system 602 further includes a video interface 676 that enables an operation of an on-board camera 630 to record still images, video stream, and the like.

According to an aspect, a mobile computing device 600 implementing the system 602 has additional features or functionality. For example, the mobile computing device 600 includes additional data storage devices (removable and/or non-removable) such as, magnetic disks, optical disks, or tape. Such additional storage is illustrated in FIG. 6B by the non-volatile storage area 668.

According to an aspect, data/information generated or captured by the mobile computing device 600 and stored via the system 602 is stored locally on the mobile computing device 600, as described above. According to another aspect, the data is stored on any number of storage media that are accessible by the device via the radio 672 or via a wired connection between the mobile computing device 600 and a separate computing device associated with the mobile computing device 600, for example, a server computer in a distributed computing network, such as the Internet. As should be appreciated such data/information is accessible via the mobile computing device 600 via the radio 672 or via a distributed computing network. Similarly, according to an aspect, such data/information is readily transferred between computing devices for storage and use according to well-known data/information transfer and storage means, including electronic mail and collaborative data/information sharing systems.

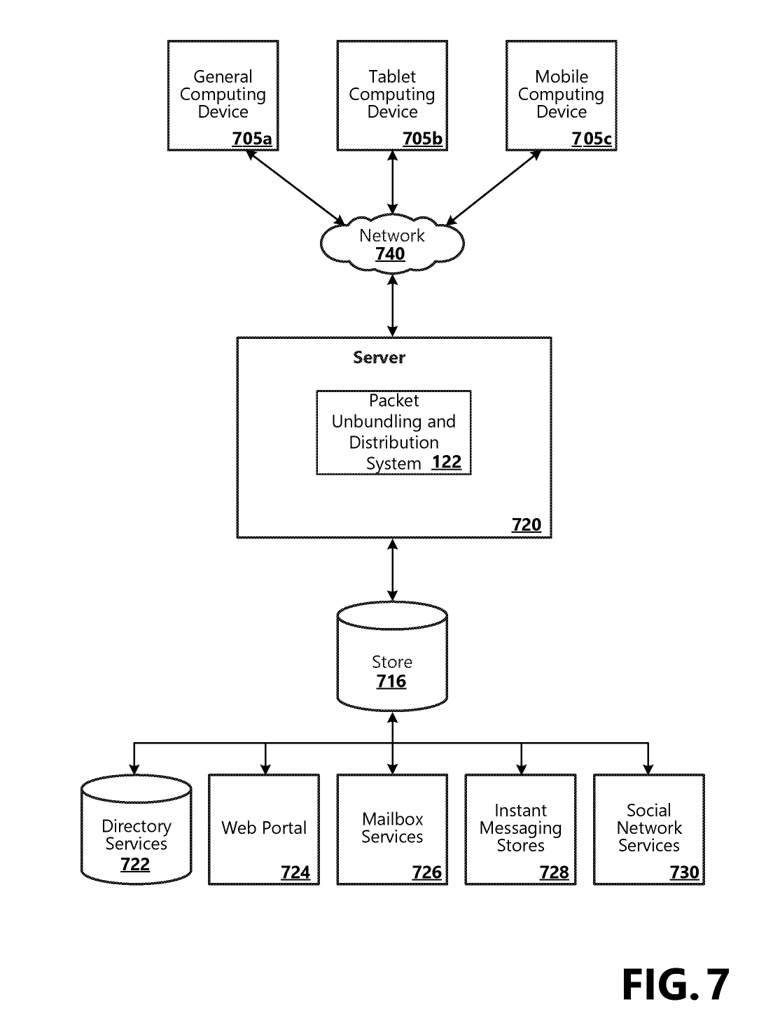

FIG. 7 illustrates one example of the architecture of a system for identifying and apportioning a packet 114 amongst disparate users 102 based on each user's identified user needs 202 as described above. Content developed, interacted with, or edited in association with the one or more components of the packet unbundling and distribution system 122 is enabled to be stored in different communication channels or other storage types. For example, various documents may be stored using a directory service 722, a web portal 724, a mailbox service 726, an instant messaging store 728, or a social networking site 730. One or more components of the packet unbundling and distribution system 122 are operative or configured to use any of these types of systems or the like for identifying and apportioning a packet 114 amongst disparate users 102 based on each user's identified user needs 202, as described herein. According to an aspect, a server 720 provides the one or more components of the packet unbundling and distribution system 122 to clients 705a, b, c. As one example, the server 720 is a web server providing one or more components of the packet unbundling and distribution system 122 over the web. The server 720 provides one or more components of the packet unbundling and distribution system 122 over the web to clients 705 through a network 740. By way of example, the client computing device is implemented and embodied in a personal computer 705a, a tablet computing device 705b or a mobile computing device 705c (e.g., a smart phone), or other computing device. Any of these examples of the client computing device are operable to obtain content from the store 716.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

We claim:

1. A system for preserving user data security in a shared packet transaction, the system comprising:
at least one processing device; and
at least one computer readable data storage device storing instructions that, when executed by the at least one processing device, cause the system to:
responsive to collecting user signals associated with a plurality of disparate users, determine user needs of the disparate users based on the collected user signals;
collect packet data associated with offered packets comprised of a plurality of divisible packet elements;
map the user needs of the disparate users to packet elements;
determine matches between the user needs and the packet elements;
upon determining that a threshold associated with a packet is satisfied, generate a virtual group of disparate users whose user needs match at least a portion of the packet elements of the packet;
transmit a notification to each of the disparate users of the virtual group, wherein the notification informs a given user of the match between one or more user needs and one or more packet elements for the given user;
receive responses to the notification; and
responsive to determining that the received responses meet the threshold associated with the packet, facilitate transactions of the matched packet elements.

2. The system of claim 1, wherein in determining the user needs of the disparate users, the system is configured to identify an explicitly-defined entity in a collected user signal as a user need.

3. The system of claim 1, wherein in determining user needs of the disparate users, the system is configured to infer a user need for a particular user based at least in part on at least one from a group of user signals comprising:
a search history for the particular user;
a purchase history for the particular user;
schedule and calendar data for the particular user;
social-network data for the particular user;
communications for the particular user; and
data sensed via one or more sensors of one or more client computing devices associated with the particular user.

4. The system of claim 1, wherein in determining the user needs of the disparate users, the system is further configured to determine user preferences for a particular user based on the collected user signals.

5. The system of claim 4, wherein in determining matches between the user needs and the packet elements, the system is configured to rank the packet elements based on a level of relatedness between a given packet element and an identified user need and the user preferences.

6. The system of claim 1, wherein the threshold associated with the packet is one of:
a minimum quantity of packet elements; or
a combination of all or a predetermined portion of particular packet elements.

7. The system of claim 6, wherein in determining that the threshold associated with the packet is satisfied, the system is configured to:
identify, from the collected packet data, the threshold associated with the packet; and
determine whether identified matches between the user needs and the packet elements meet the threshold.

8. The system of claim 1, wherein the notification comprises a selectable option, which when selected by a particular user, transmits a response that opts the particular user into a shared transaction of an associated packet.

9. The system of claim 1, wherein in facilitating the transactions of the matched packet elements, the system is configured to:
transmit payment to a product or service provider on behalf of a particular user of the virtual group; or
secure a reservation for the product or service on behalf of an individual user of the virtual group.

10. A computer-implemented method for preserving user data security when sharing a packet amongst disparate users, comprising:
collecting user signals associated with a plurality of disparate users;
based on the collected user signals, inferring user needs and user preferences and identifying explicitly-defined user needs and user preferences;
collecting packet data associated with offered packets, wherein the offered packets are comprised of a divisible plurality of packet elements;
mapping the user needs to the packet elements;
determining matches between the user needs and the packet elements;
upon determining that a threshold associated with a packet is satisfied, generating a virtual group of disparate users whose user needs match at least a portion of the packet elements of the packet;
transmitting a notification to each of the disparate users of the virtual group, wherein the notification informs a given user of the match between one or more of the user needs for the given user and one or more packet elements;
receiving responses to the notification; and
responsive to determining that the received responses meet the threshold associated with the packet, facilitating transactions of the matched packet elements.

11. The method of claim 10, wherein inferring the user needs and the user preferences comprises inferring the user needs and the user preferences based at least in part on at least one from a group of user signals comprising:
a user search history;
a user purchase history;
user schedule and calendar data;
user social-network data;
user communications; and
data sensed via one or more sensors of one or more client computing devices associated with the given user.

12. The method of claim 10, wherein determining matches between the user needs and the packet elements comprises ranking the packet elements based on a level of relatedness between a packet element, an identified user need, and an identified user preference.

13. The method of claim 10, wherein determining that the threshold associated with the packet is satisfied comprises:
identifying, from the collected packet data, the threshold associated with the packet, wherein the threshold is one of:
a minimum quantity of packet elements; or
a combination of all or a predetermined portion of particular packet elements; and
determining whether identified matches between the user needs and the packet elements meet the threshold.

14. The method of claim 10, wherein transmitting the notification to each of the disparate users of the virtual group comprises providing a selectable option, which when selected by the given user, transmits a response that opts the given user into a shared transaction of an associated packet.

15. The method of claim 10, wherein facilitating the transactions of the matched packet elements comprises at least one of:
transmitting payment to a product or service provider on behalf of an individual user of the virtual group; and
securing a reservation for the product or service on behalf of the individual user of the virtual group.

16. A computer readable storage device including computer readable instructions, which when executed by a processing unit is configured to:
collect user signals associated with a plurality of disparate users;
determine user needs and user preferences based on the collected user signals for the disparate users;
collect packet data associated with offered packets comprised of a divisible plurality of packet elements;
map the user needs of the disparate users to the packet elements;
determine matches between the user needs and the packet elements;
upon determining that a threshold associated with a packet is satisfied, generate a virtual group of disparate users whose user needs match at least a portion of the packet elements of the packet;
transmit a notification to each of the disparate users of the virtual group, wherein the notification informs a given user of the match between one or more of the user needs of the given user and one or more packet elements;
receive responses to the notification; and
responsive to determining that the received responses meet the threshold associated with the packet, facilitate the transactions of the matched packet elements.

17. The computer readable storage device of claim 16, wherein in determining the user needs and the user preferences for the disparate users, the computer readable storage device is further configured to:
identify an explicitly-defined entity in a collected user signal as a user need; and
infer a user need for a user based at least in part on the collected user signals.

18. The computer readable storage device of claim 17, wherein the collected user signals comprises at least one of:
search history;
purchase history;
schedule and calendar data;
social-network data;
communications; and
data sensed via one or more sensors of one or more client computing devices associated with the disparate users.

19. The computer readable storage device of claim 16, wherein in determining matches between the user needs and the packet elements, the computer readable storage device is further configured to rank packet elements based on a level of relatedness between a packet element and an identified user need and the user preferences.

20. The computer readable storage device of claim 16, wherein in determining that the threshold associated with the packet is satisfied, the computer readable storage device is further configured to:
identify, from the collected packet data, the threshold associated with the packet, wherein the threshold is one of:
a minimum quantity of packet elements; or
a combination of all or a predetermined portion of particular packet elements; and
determine whether identified matches between user needs and packet elements meet the threshold.
